(19) United States
(12) Patent Application Publication
(10) Pub. No.: US 2023/0036265 A1
(43) Pub. Date: Feb. 2, 2023

(54) METHOD AND APPARATUS FOR CONTROLLING VIRTUAL CHARACTERS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Feng LIU, Shenzhen (CN)

(73) Assignee: Tencent Technology (Shenzhen) Company Limited, Shenzhen (CN)

(21) Appl. No.: 17/965,105

(22) Filed: Oct. 13, 2022

Related U.S. Application Data
(63) Continuation of application No. PCT/CN2021/140900, filed on Dec. 23, 2021.

(30) Foreign Application Priority Data
Jan. 15, 2021 (CN) 2021100528718

(51) Int. Cl. A63F 13/58; A63F 13/56; A63F 13/537

(52) U.S. Cl. CPC A63F 13/58; A63F 13/56; A63F 13/537

(57) ABSTRACT

A method and an apparatus for controlling a virtual character, an electronic device, a computer-readable storage medium, and a computer program product are provided. The method includes: displaying a virtual scene, the virtual scene including a first camp and a second camp that fight against each other; displaying a combined attack skill cast towards a second virtual character in the second camp in response to positions of a first virtual character and at least one teammate character in the first camp meeting a combined attack skill trigger condition; and displaying a state of the second virtual character in response to the combined attack skill, the combined attack skill including at least one attack skill cast by the first virtual character and at least one attack skill cast by the at least one teammate character.

### RELATED APPLICATIONS

This application is a continuation of International Application No. PCT/CN2021/140900, filed Dec. 23, 2021, which claims priority to Chinese Patent Application No. 202110052871.8, filed on Jan. 15, 2021. The contents of International Application No. PCT/CN2021/140900 and Chinese Patent Application No. 202110052871.8 are each incorporated herein by reference in their entirety.

### FIELD OF THE TECHNOLOGY

This application relates to human-computer interaction technologies, and in particular, to a method and an apparatus for controlling a virtual character, an electronic device, a computer-readable storage medium, and a computer program product.

### BACKGROUND OF THE DISCLOSURE

Graphics processing hardware-based virtual scene human computer interaction technologies can implement diversified interaction between virtual characters controlled by users or artificial intelligence according to an actual application requirement, which has a wide practical value. For example, in a game virtual scene, a real battle process between virtual characters can be simulated.

In the virtual scene, users may control a plurality of virtual characters in the same camp to form an attack formation, to cast a combined attack skill (or referred to as a combination attack) towards target virtual characters in an opposing camp.

However, in the related art, a mechanism for triggering the combined attack skill is relatively complex and difficult to understand, which does not meet a requirement of a lightweight design of a current game (especially a mobile game). In addition, due to the complexity of the trigger mechanism of the combined attack skill, a large amount of computing resources need to be consumed when an electronic device (for example, a terminal device) processes scene data.

### SUMMARY

Embodiments of this application provide a method and an apparatus for controlling a virtual character, an electronic device, a computer-readable storage medium, and a computer program product, which can implement interaction based on a combined attack skill in an efficient manner with intensive resources, to reduce computing resources that need to be consumed by the electronic device during interaction.

Technical solutions in the embodiments of this application are implemented as follows:

An embodiment of this application provides a method for controlling a virtual character, including:

displaying a virtual scene, the virtual scene including a first camp and a second camp that fight against each other;

displaying a combined attack skill cast towards a second virtual character in the second camp in response to positions of a first virtual character and at least one teammate character in the first camp meeting a combined attack skill trigger condition; and

displaying a state of the second virtual character in response to the combined attack skill,

the combined attack skill including at least one attack skill cast by the first virtual character and at least one attack skill cast by the at least one teammate character.

An embodiment of this application provides an apparatus for controlling a virtual character, including:

a display module, configured to display a virtual scene, the virtual scene including a first camp and a second camp that fight against each other;

the display module being further configured to display a combined attack skill cast towards a second virtual character in the second camp in response to positions of a first virtual character and at least one teammate character in the first camp meeting a combined attack skill trigger condition; and

display a state of the second virtual character in response to the combined attack skill,

the combined attack skill including at least one attack skill cast by the first virtual character and at least one attack skill cast by the at least one teammate character.

An embodiment of this application provides an electronic device, including:

a memory, configured to store executable instructions; and

a processor, configured to implement the method for controlling a virtual character provided in the embodiments of this application when executing the executable instructions stored in the memory.

An embodiment of this application provides a computer-readable storage medium, storing executable instructions, the executable instructions, when executed by a processor, implementing the method for controlling a virtual character provided in the embodiments of this application.

An embodiment of this application provides a computer program product, including a computer program or instructions, used for implementing the method for controlling a virtual character provided in the embodiments of this application when executed by a processor.

The embodiments of this application have the following beneficial effects:

When it is necessary to attack a second virtual character in an opposing camp, positions of a first virtual character and at least one teammate character in a same camp in a virtual scene are used as a trigger condition for casting a combined attack skill, to simplify a trigger mechanism of the combined attack skill, thereby reducing the computing resources that need to be consumed by the electronic device during interaction based on the combined attack skill.

### BRIEF DESCRIPTION OF THE DRAWINGS

FIG. 1A is a schematic diagram of an application mode of a method for controlling a virtual character according to an embodiment of this application.

FIG. 1B is a schematic diagrams of an application mode of a method for controlling a virtual character according to an embodiment of this application.

FIG. 2 is a schematic structural diagram of a terminal device 400 according to an embodiment of this application.

FIG. 3 is a schematic flowchart of a method for controlling a virtual character according to an embodiment of this application.

FIG. 4A is a schematic diagram of an application scenario of a method for controlling a virtual character according to an embodiment of this application.

FIG. 4B is a schematic diagram of an application scenario of a method for controlling a virtual character according to an embodiment of this application.

FIG. 4C is a schematic diagram of an application scenario of a method for controlling a virtual character according to an embodiment of this application.

FIG. 5 is a schematic diagram of application and training of a neural network model according to an embodiment of this application.

FIG. 6 is a schematic structural diagram of a neural network model according to an embodiment of this application.

FIG. 7 is a schematic diagram of determining a combined attack skill according to feature data by using a neural network model according to an embodiment of this application.

FIG. 8 is a schematic flowchart of a method for controlling a virtual character according to an embodiment of this application.

FIG. 9 is a schematic diagram of an application scenario of a method for controlling a virtual character according to an embodiment of this application.

FIG. 10 is a schematic diagram of an application scenario of a method for controlling a virtual character according to an embodiment of this application.

FIG. 11 is a schematic diagram of an application scenario of a method for controlling a virtual character according to an embodiment of this application.

FIG. 12 is a schematic diagram of a rule of triggering a combination attack according to an embodiment of this application.

FIG. 13 is a schematic diagram of design of an attack sequence according to an embodiment of this application.

FIG. 14 is a schematic diagram of a lens design in a combination attack process according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes subsets of all possible embodiments, but it may be understood that “some embodiments” may be the same subset or different subsets of all the possible embodiments, and can be combined with each other without conflict.

In the following descriptions, the included term “first/second/third” is merely intended to distinguish similar objects but does not necessarily indicate a specific order of an object. It may be understood that “first/second/third” is interchangeable in terms of a specific order or sequence if permitted, so that the embodiments of this application described herein can be implemented in a sequence in addition to the sequence shown or described herein.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, a description is made on terms in the embodiments of this application, and the terms in the embodiments of this application are applicable to the following explanations.

(1) “In response to” is used for representing a condition or status on which one or more operations to be performed depend. When the condition or status is satisfied, the one or more operations may be performed immediately or after a set delay. Unless explicitly stated, there is no limitation on the order in which the plurality of operations are performed.

(2) Client is an application such as a video playback client or a game client running in a terminal device and configured to provide various services.

(3) Virtual scene is a scene displayed (or provided) by an application when run on a terminal device. The scene may be a simulated environment of a real world, or may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene, and the dimension of the virtual scene is not limited in the embodiments of this application. For example, the virtual scene may comprise the sky, the land, the ocean, or the like. The land may comprise environmental elements such as the desert and a city. The user may control the virtual character to move in the virtual scene.

(4) Virtual characters are images of various people and objects that may interact in a virtual scene, or movable objects in a virtual scene. The movable object may be a virtual character, a virtual animal, a cartoon character, or the like, such as a character or an animal displayed in a virtual scene. The virtual character may be a virtual image used for representing a user in the virtual scene. The virtual scene may include a plurality of virtual characters, and each virtual character has a shape and a volume in the virtual scene, and occupies some space in the virtual scene.

For example, the virtual character may be a user character controlled through an operation on a client, or may be an artificial intelligence (AI) character set in a virtual scene battle through training, or may be a non-player character (NPC) set in a virtual scene interaction. For example, the virtual character may be a virtual character for adversarial interaction in a virtual scene. For example, a quantity of virtual characters participating in the interaction in the virtual scene may be preset, or may be dynamically determined according to a quantity of clients participating in the interaction.

(5) Scene data represents various features of virtual characters in a virtual scene during interaction, for example, may include positions of the virtual characters in the virtual scene. Certainly, different types of features may be included according to types of the virtual scenes. For example, in a game virtual scene, the scene data may include a waiting time (which depends on a quantity of times that a same function is used within a specific time) required for configuring various functions in the virtual scene, or may include attribute values representing various states of the virtual character, for example, include a health value (or referred to as a health point) and a magic value (or referred to as a magic point).

(6) Combination attack, at least two virtual characters cooperate to make an attack, each virtual character casts at least one attack skill, and an attack skill cast during a combination attack is referred to as a combined attack skill.

In a virtual scene, users may control a plurality of virtual characters in a same camp to form an attack formation, to perform a combination attack (which corresponds to the combined attack skill) on target virtual objects in an opposing camp.

However, in the related art, a trigger mechanism of the combination attack is relatively complex and difficult to understand. A game is used as an example, and the trigger mechanism of the combination attack does not meet a requirement of a lightweight design of the game (especially a mobile game). In addition, an attacked virtual character may also trigger a combination attack again during counterattack, increasing complexity of the game. As a result, the terminal device needs to consume a large amount of computing resources when processing scene data.

For the technical problem, the embodiments of this application provide a method and an apparatus for controlling a virtual character, an electronic device, a computer-readable storage medium, and a computer program product, which can trigger a combined attack skill in a simple manner with low resource consumption, to reduce the computing resources that need to be consumed by the electronic device during interaction. For ease of understanding the method for controlling a virtual character provided in the embodiments of this application, an exemplary implementation scenario of the method for controlling a virtual character provided in the embodiments of this application is first described. In the method for controlling a virtual character provided in the embodiments of this application, a virtual scene may be completely outputted based on a terminal device or cooperatively outputted based on a terminal device and a server.

In some embodiments, the virtual scene may be an environment for game characters to interact, for example, for the game characters to perform a battle in the virtual scene. By controlling actions of the virtual characters, both parties may interact in the virtual scene, so that the users can relieve the pressure of life during the game.

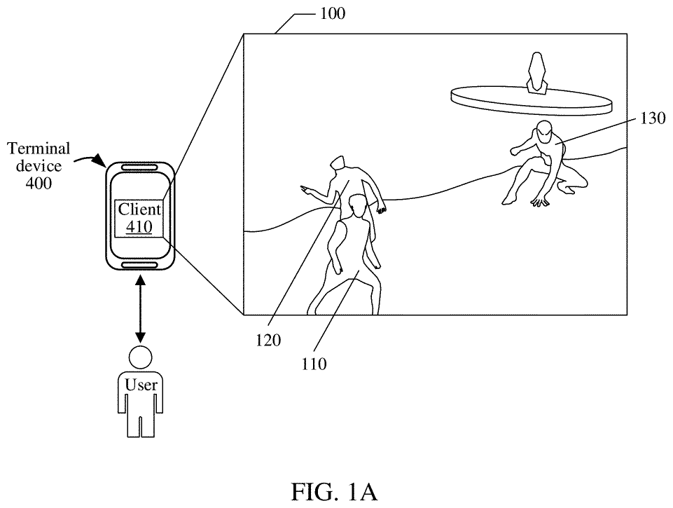

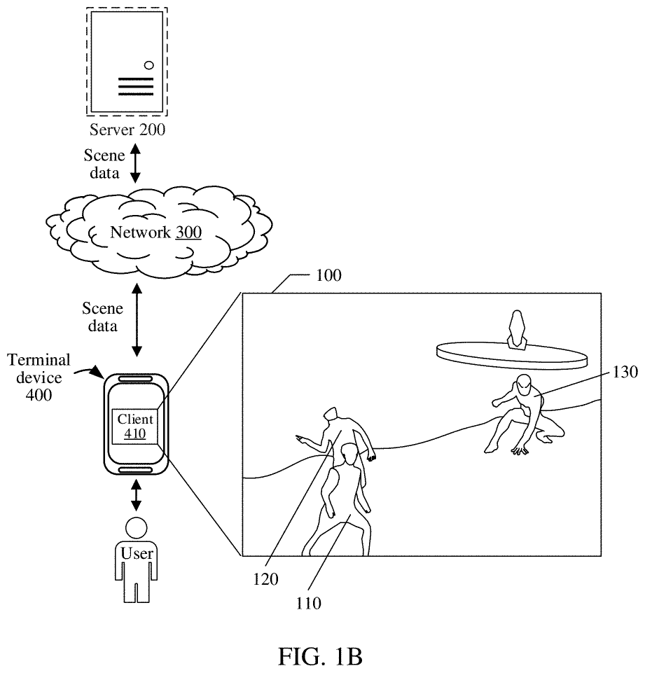

In an implementation scenario, FIG. 1A is a schematic diagram of an application mode of a method for controlling a virtual character according to an embodiment of this application. The method is applicable to some application modes that completely rely on a computing capability of graphics processing hardware of a terminal device 400 to complete calculation of relevant data of a virtual scene 100, for example, a standalone/offline game, to output a virtual scene by using the terminal device 400 such as a smartphone, a tablet computer, and a virtual reality/augmented reality device.

As an example, types of the graphics processing hardware includes a central processing unit (CPU) and a graphics processing unit (GPU).

When forming visual perception of the virtual scene 100, the terminal device 400 calculates, by using graph computing hardware, data required by display, completes loading, parsing, and rendering of the to-be-displayed data, and outputs, by using graph output hardware, a video frame that can form the visual perception for the virtual scene, for example, displays a two-dimensional video frame in a display screen of a smartphone or project a video frame in a three-dimensional display effect on lens of augmented reality/virtual reality glasses. In addition, to enrich a perception effect, the terminal device 400 may further form one or more of auditory perception, tactile perception, motion perception, and taste perception through different hardware.

As an example, a client 410 (for example, a standalone game application) runs on the terminal device 400, and a virtual scene including role-playing is outputted during running of the client 410. The virtual scene is an environment for game characters to interact, for example, may be a plain, a street, or a valley for the game characters to perform a battle. The virtual scene includes a first camp and a second camp that fight against each other. The first camp includes a first virtual character 110 and a teammate character 120, and the second camp includes a second virtual character 130. The first virtual character 110 may be a game character controlled by a user (or referred to as a player), that is, the first virtual character 110 is controlled by a real user, and the first virtual character moves in the virtual scene in response to an operation of the real user on a controller (which includes a touchscreen, a sound control switch, a keyboard, a mouse, a joystick, and the like). For example, when the real user moves the joystick to the left, the virtual character moves to the left in the virtual scene or may stay still, jump, and use various functions (for example, skills and props).

For example, when positions of the first virtual character 110 and the teammate character 120 in the first camp in the virtual scene 100 meet a combined attack skill trigger condition (for example, when the positions of the first virtual character 110 and the teammate character 120 in the virtual scene 100 meet a set position relationship, it is determined that the combined attack skill trigger condition is met), a combined attack skill cast towards the second virtual character 130 in the second camp is displayed, that is, at least one attack skill cast by the first virtual character 110 towards the second virtual character 130 and at least one attack skill cast by the teammate character 120 towards the second virtual character 130 are sequentially displayed in the virtual scene 100. In addition, a state of the second virtual character 130 in response to the combined attack skill may further be displayed in the virtual scene 100.

In another implementation scenario, FIG. 1B is a schematic diagram of an application mode of a method for controlling a virtual character according to an embodiment of this application. The method is applicable to a terminal device 400 and a server 200 and is applicable to an application mode in which virtual scene computing is completed depending on a computing capability of the server 200 and a virtual scene is outputted by the terminal device 400.

An example of forming visual perception of a virtual scene 100 is used. The server 200 calculates display data related to a virtual scene and sends the display data to the terminal device 400 through a network 300. The terminal device 400 completes loading, parsing, and rendering of the display data depending on graphic computing hardware, and outputs the virtual scene depending on graphic output hardware, to form the visual perception, for example, may display a two-dimensional video frame in a display screen of a smartphone or project a video frame in a three-dimensional display effect in lens of augmented reality/virtual reality glasses. It may be understood that the perception formed for the virtual scene may be outputted through the related hardware of the terminal, for example, auditory perception is formed and outputted by using a microphone, and tactile perception is formed and outputted by using a vibrator.

As an example, the terminal device 400 runs a client 410 (for example, a network game application), and the client is connected to a game server (that is, the server 200) to perform game interaction with another user. The terminal device 400 outputs a virtual scene 100 of the client 410, the virtual scene 100 including a first camp and a second camp that fight against each other, the first camp including a first virtual character 110 and a teammate character 120, and the second camp including a second virtual character 130. The first virtual character 110 may be a game character controlled by a user, that is, the first virtual character 110 is controlled by a real user, and the first virtual character moves in the virtual scene in response to an operation of the real user on a controller (which includes a touchscreen, a sound control switch, a keyboard, a mouse, a joystick, and the like). For example, when the real user moves the joystick to the left, the virtual character moves to the left in the virtual scene or may stay still, jump, and use various functions (for example, skills and props).

For example, when positions of the first virtual character 110 and the teammate character 120 in the first camp in the virtual scene 100 meet a combined attack skill trigger condition, a combined attack skill cast towards the second virtual character 130 in the second camp is displayed, that is, at least one attack skill cast by the first virtual character 110 towards the second virtual character 130 and at least one attack skill cast by the teammate character 120 towards the second virtual character 130 are sequentially displayed in the virtual scene 100. In addition, a state of the second virtual character 130 in response to the combined attack skill may further be displayed in the virtual scene 100.

In some other embodiments, when both a first virtual character and at least one teammate character (for example, a teammate character A) have a plurality of attack skills, for example, it is assumed that the first virtual character has three attack skills, which are respectively an attack skill 1, an attack skill 2, and an attack skill 3, and the teammate character A has two attack skills, which are respectively an attack skill 4 and an attack skill 5, a cast sequence of the combined attack skill may be that each virtual character performs casting once in each round, that is, the cast sequence of the attack skills is that the first virtual character casts the attack skill 1→the teammate character A casts the attack skill 4→the first virtual character casts the attack skill 2→the teammate character A casts the attack skill 5→the first virtual character casts the attack skill 3. Certainly, the cast sequence of the combined attack skill may alternatively be that each virtual character casts a plurality of attack skills at a time in each round, and then a next virtual character performs an attack, that is, the cast sequence of the attack skills is that: the first virtual character casts the attack skill 1→the first virtual character casts the attack skill 2→the first virtual character casts the attack skill 3→the teammate character A casts the attack skill 4→the teammate character A casts the attack skill 5.

In some embodiments, the terminal device 400 may implement, by running a computer program, the method for controlling a virtual character provided in this embodiment of this application. For example, the computer program may be a native program or a software module in an operating system. The computer program may be a native application (APP), that is, a program that needs to be installed in the operating system before the program can run, for example, a game APP (that is, the client 410). Alternatively, the computer program may be an applet, that is, a program that is executable by just being downloaded into a browser environment; Alternatively, the computer program may be a game applet that can be embedded in any APP. To sum up, the computer program may be any form of application, module or plug-in.

This embodiment of this application may further be implemented through a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system requires a large amount of computing and storage resources.

For example, the server 200 in FIG. 1B may be an independent physical server, or may be a server cluster comprising a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smartwatch, or the like, but is not limited thereto. The terminal device 400 and the server 200 may be directly or indirectly connected in a wired or wireless communication manner. This is not limited in this embodiment of this application.

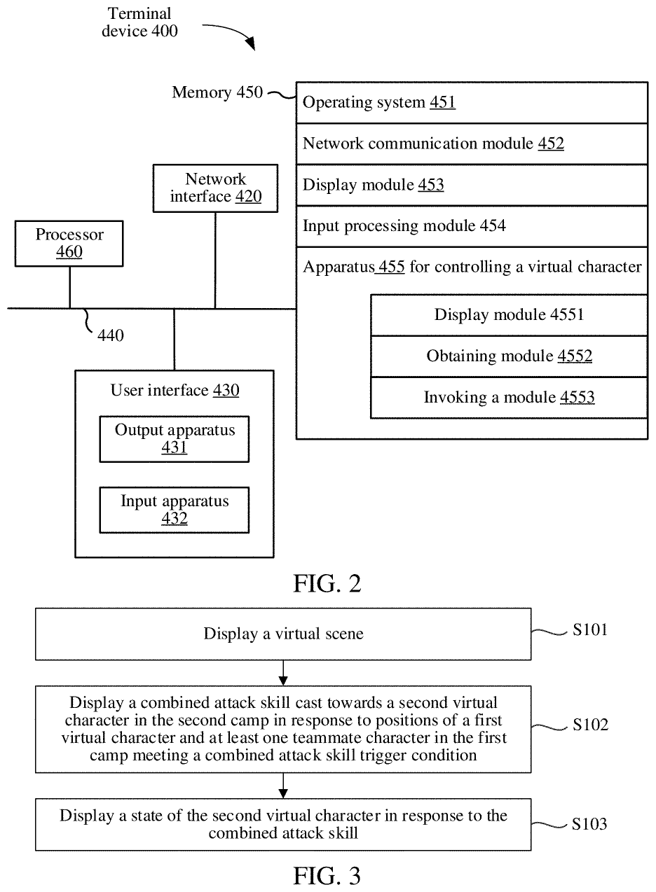

The following describes a structure of the electronic device provided in this embodiment of this application, and the electronic device may be the terminal device 400 shown in FIG. 1A and FIG. 1B. FIG. 2 is a schematic structural diagram of a terminal device 400 according to an embodiment of this application. The terminal device 400 shown in FIG. 2 includes: at least one processor 460, a memory 450, at least one network interface 420, and a user interface 430. All the components in the terminal device 400 are coupled together by using the bus system 440. It may be understood that the bus system 440 is configured to implement connection and communication between the components. In addition to a data bus, the bus system 440 further includes a power bus, a control bus, and a status signal bus. However, for ease of clear description, all types of buses are marked as the bus system 440 in FIG. 2.

The processor 460 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The user interface 430 includes one or more output apparatuses 431 that can display media content, comprising one or more speakers and/or one or more visual display screens. The user interface 430 further includes one or more input apparatuses 432, comprising user interface components that facilitate inputting of a user, such as a keyboard, a mouse, a microphone, a touch display screen, a camera, and other input button and control.

The memory 450 may be a removable memory, a non-removable memory, or a combination thereof. Exemplary hardware devices include a solid-state memory, a hard disk drive, an optical disc driver, or the like. The memory 450 optionally includes one or more storage devices physically away from the processor 460.

The memory 450 includes a volatile memory or a non-volatile memory, or may include a volatile memory and a non-volatile memory. The non-volatile memory may be a read-only memory (ROM). The volatile memory may be a random access memory (RAM). The memory 450 described in this embodiment of this application is to include any other suitable type of memories.

In some embodiments, the memory 450 can store data to support various operations, and examples of the data include programs, modules, and data structures, or subsets or supersets thereof, as illustrated below.

An operating system 451 includes a system program configured to process various basic system services and perform a hardware-related task, for example, a framework layer, a core library layer, and a driver layer, and is configured to implement various basic services and process a hardware-related task.

A network communication module 452 is configured to reach another computing device through one or more (wired or wireless) network interfaces 420. Exemplary network interfaces 420 include: Bluetooth, wireless compatible authentication (WiFi), a universal serial bus (USB), and the like.

A display module 453 is configured to display information by using an output apparatus 431 (for example, a display screen or a speaker) associated with one or more user interfaces 430 (for example, a user interface configured to operate a peripheral device and display content and information).

An input processing module 454 is configured to detect one or more user inputs or interactions from one of the one or more input apparatuses 432 and translate the detected input or interaction.

In some embodiments, the apparatus provided in this embodiment of this application may be implemented by using software. FIG. 2 shows an apparatus 455 for controlling a virtual character stored in the memory 450. The apparatus 455 may be software in a form such as a program and a plug-in, and includes the following software modules: a display module 4551, an obtaining module 4552, and an invoking module 4553. These modules are logical modules, and may be randomly combined or further divided based on a function to be performed. For ease of description, the foregoing modules are shown in FIG. 2 at a time, but it is not to be considered as that an implementation in which the apparatus 455 for controlling a virtual character may include only the display module 4551 is excluded. The following describes functions of the modules.

The method for controlling a virtual character provided in the embodiments of this application is described below with reference to the accompanying drawings. The method for controlling a virtual character provided in this embodiment of this application may be performed by the terminal device 400 alone in FIG. 1A, or may be performed by the terminal device 400 and the server 200 in cooperation in FIG. 1B.

A description is made below by using an example in which the method for controlling a virtual character provided in the embodiments of this application is performed by the terminal device 400 in FIG. 1A. FIG. 3 is a schematic flowchart of a method for controlling a virtual character according to an embodiment of this application, and steps shown in FIG. 3 are combined for description.

The method shown in FIG. 3 may be performed by computer programs in various forms running in the terminal device 400, which is not limited to the client 410, for example, the operating system 551, the software module, and the script. Therefore, the client is not to be considered as a limitation to this embodiment of this application.

Step S101. Display a virtual scene.

Herein, the virtual scene displayed in a human-computer interaction interface of the terminal device may include a first camp and a second camp that fight against each other. The first camp includes a first virtual character (for example, a virtual character controlled by a user) and at least one teammate character (which may be a virtual character controlled by another user or a virtual character controlled by a robot program). The second camp includes at least one second virtual character (which may be a virtual character controlled by another user or a virtual character controlled by a robot program).

In some embodiments, the human-computer interaction interface may display the virtual scene from a first-person perspective (for example, a first virtual character in a game is played from a perspective of a user); or may display the virtual scene from a third-person perspective (for example, a user plays a game by following a first virtual character in the game); or may display the virtual scene from a bird's-eye perspective. The perspectives may be switched arbitrarily.

As an example, the first virtual character may be an object controlled by a user in a game. Certainly, the virtual scene may further include another virtual character, which may be controlled by another user or a robot program. The first virtual character may be divided into any team of a plurality of teams, the teams may be in a hostile relationship or a cooperative relationship, and the teams in the virtual scene may include one or all of the relationships.

For example, the virtual scene is displayed from the first-person perspective. The displaying a virtual scene in a human-computer interaction interface may include: determining a field-of-view region of the first virtual character according to a viewing position and a field of view of the first virtual character in the entire virtual character, and displaying a partial virtual scene of the entire virtual scene in the field-of-view region, that is, the displayed virtual scene may be the partial virtual scene relative to a panorama virtual scene. Because the first-person perspective is a most powerful viewing perspective for a user, immersive perception for the user during operation can be achieved.

For example, the virtual scene is displayed from the bird's-eye perspective. The displaying a virtual scene in a human-computer interaction interface may include: displaying, in response to a zooming operation on a panorama virtual scene, a partial virtual scene corresponding to the zooming operation in the human-computer interaction interface, that is, the displayed virtual scene may be a partial virtual scene relative to the panorama virtual scene. Therefore, operability of the user during operation can be improved, thereby improving human-computer interaction efficiency.

Step S102. Display a combined attack skill cast towards a second virtual character in the second camp in response to positions of a first virtual character and at least one teammate character in the first camp meeting a combined attack skill trigger condition

In some embodiments, the combined attack skill trigger condition may include at least one of the following: a position of the second virtual character in the virtual scene is within an attack range of the first virtual character and is within an attack range of the at least one teammate character; or an orientation of the first virtual character relative to the at least one teammate character is a set orientation or falls within a set orientation range.

For example, a war chess game is used as an example. It is assumed that the attack range of the first virtual character is a circular region with a position of the first virtual character as a center and a radius of three grids (or referred to as a grid, that is, a logical unit grid in a unit of a square, and in the war chess game, a specific quantity of connected grids may form a level map). In addition, it is assumed that two grids are spaced between the second virtual character and the first virtual character, that is, the second virtual character is within the attack range of the first virtual character. In addition, it is assumed that there is a teammate character A belonging to a same camp with the first virtual character in the virtual scene, one grid is spaced between the teammate character A and the first virtual character, and an attack range of the teammate character A is also a circular region with a radius of three grids, that is, the second virtual character is also within the attack range of the teammate character A, the terminal device may determine that positions of the first virtual character and the teammate character A meet the combined attack skill trigger condition. That is, when the positions of the first virtual character and the teammate character A meet a set position relationship, the first virtual character and the teammate character A may be combined into a lineup combination, and cast a combined attack skill towards the second virtual character in the second camp.

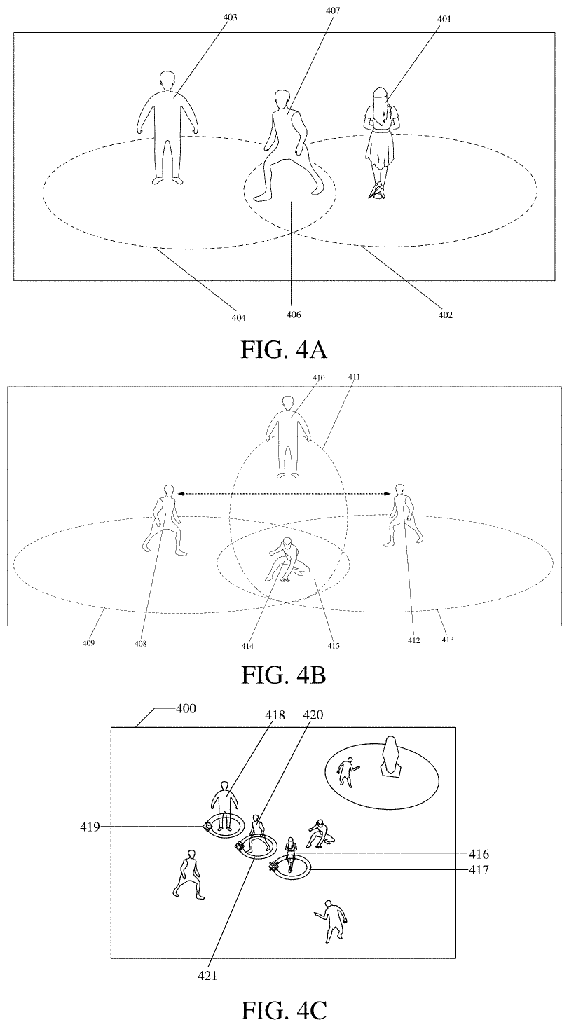

For example, FIG. 4A is a schematic diagram of an application scenario of a method for controlling a virtual character according to an embodiment of this application. As shown in FIG. 4A, an attack range of a first virtual character 401 is a first circular region 402, and an attack range of a teammate character 403 is a second circular region 404. When a second virtual character 407 is in an intersection range 406 between the first circular region 402 and the second circular region 404 (in this case, both the first virtual character 401 and the teammate character 403 can attack the second virtual character 407), the terminal device determines that positions of the first virtual character and the teammate character meet a combined attack skill trigger condition.

For example, when an attack range of a virtual character has directivity (that is, attack ranges in different directions are different), orientations of the first virtual character and at least one teammate character need to be further considered. For example, when a position of the second virtual character in the virtual scene is in an attack range corresponding to a current orientation of the first virtual character (that is, a current orientation of the first virtual character) and is in an attack range corresponding to a current orientation of a teammate character B (that is, a current orientation of the teammate character B) belonging to the same camp with the first virtual character, the terminal device determines that positions of the first virtual character and the teammate character B meet the combined attack skill trigger condition.

For example, in addition to the attack range, the set position relationship may further be related to an orientation of a virtual character. For example, when the first virtual character and the at least one teammate character can attack the second virtual character simultaneously, and an orientation of the first virtual character relative to the at least one teammate character is a set orientation or falls within a set orientation range, the terminal device determines that positions of the first virtual character and the at least one teammate character meets the combined attack skill trigger condition. For example, it is assumed that only a teammate character C in a plurality of teammate characters meeting the attack range is in a line of sight of the first virtual character, the terminal device determines that positions of the first virtual character and the teammate character C meet the combined attack skill trigger condition.

For example, FIG. 4B is a schematic diagram of an application scenario of a method for controlling a virtual character according to an embodiment of this application. As shown in FIG. 4B, an attack range of a first virtual character 408 is a first circular region 409, an attack range of a first teammate character 410 is a second circular region 411, an attack range of a second teammate character 412 is a third circular region 413, and a second virtual character 414 is in an intersection region 415 of the first circular region 409, and the second circular region 411, and the third circular region 413, that is, all the first virtual character 408, the first teammate character 410, and the second teammate character 412 can attack the second virtual character 414, but an orientation of the first teammate character 410 relative to the first virtual character 408 does not fall within a set orientation range, for example, when a user controls the first virtual character 408 in a first-person mode, the first teammate character 410 is not in a field of view of the first virtual character 408, and the second teammate character 412 is in the field of view of the first virtual character 408, the terminal device determines that positions of the first virtual character 408 and the second teammate character 412 meet the combined attack skill trigger condition and selects the second teammate character 412 to participate in a subsequent combination attack.

The second virtual character involved in this embodiment of this application is only a kind of character but is not limited to one virtual character, and there may also be a plurality of second virtual characters. For example, when there are a plurality of virtual characters in the second camp, all the virtual characters may be used as the second virtual characters.

In some embodiments, the terminal device may display the combined attack skill cast towards the second virtual character in the second camp in response to the positions of the first virtual character and the at least one teammate character in the first camp meeting the combined attack skill trigger condition in the following manners: displaying the combined attack skill cast towards the second virtual character in the second camp in response to the positions of the first virtual character and the at least one teammate character in the first camp meeting the combined attack skill trigger condition and character types of the first virtual character and the at least one teammate character meeting a set lineup combination, the set lineup combination including at least one of the following: a level of the first virtual character is lower than or equal to a level of the at least one teammate character; attributes of the first virtual character and the at least one teammate character (the attribute may refer to a function of a virtual character, and virtual characters of different attributes have different functions. For example, the attribute may include power, intelligence, and agility. A function corresponding to a virtual character of which an attribute is power may be responsible for bearing damage; a function corresponding to a virtual character of which an attribute is intelligence may be responsible for treatment; and a function corresponding to a virtual character of which an attribute is agility may be responsible for attack) are the same (for example, the attributes of both the first virtual character and the teammate character are agility and are responsible for attack) or adapted to each other (for example, the attribute of the first virtual character is agility, and the attribute of the teammate character is intelligence, that is, one virtual character is responsible for attack, and the other virtual character is responsible for treatment); or skills of the first virtual character and the at least one teammate character are the same (for example, both the first virtual character and the at least one teammate character cause damage to a health point of the second virtual character) or adapted to each other (for example, the first virtual character and the at least one virtual character can cause damage to different aspects such as a health point, reduction of a moving speed, and increasing of a skill waiting time of the second virtual character).

For example, after selecting a plurality of teammate characters that meet the combined attack skill trigger condition from the virtual scene, the terminal device may further select, according to a set lineup combination, a teammate character that meets the set lineup combination from the plurality of teammate characters that meet the combined attack skill trigger condition as a final character casting the combined attack skill with the first virtual character. For example, it is assumed that the teammate characters that meet the combined attack skill trigger condition selected by the terminal device from the virtual scene are a virtual character A, a virtual character B, a virtual character C, and a virtual character D, and a current level of the first virtual character is 60, and a level of the virtual character A is 65, a level of the virtual character B is 70, a level of the virtual character C is 59, and a level of the virtual character D is 62, the terminal device determines the virtual character C as a subsequent character casting the combined attack skill with the first virtual character.

For example, the set lineup combination may further be related to an attribute of a virtual character. For example, when an attribute of the first virtual character is power (a corresponding function is responsible for bearing damage with a relatively strong defense capability), a character of which an attribute is agility (a corresponding function is responsible for attack with a relatively strong attack capability) is determined as a character meeting the set lineup combination. Therefore, through combination of different attributes, a continuous battle capability of the lineup combination can be improved, and operations and computing resources used for repeatedly initiating the combined attack skill are reduced.

For example, the set lineup combination may further be related to a skill of a virtual character. For example, when an attack type of the first virtual character is a physical attack, a character of which an attack type is a magic attack is determined as a character meeting the set lineup combination. Therefore, through combination of skills, damage of different aspects can be caused to the second virtual character, so as to maximize the damage and save the operations and the computing resources used for repeatedly casting the combined attack skill.

In some embodiments, the terminal device may select, in a sequence, the teammate character that meets the set lineup combination. For example, the terminal device first selects characters that have a same level or close levels from the plurality of teammate characters that meet the combined attack skill trigger condition, to form a lineup combination with the first virtual character. When the characters that have the same level or close levels do not exist, characters of which attributes are the same or adapted to each other are continuously selected from the plurality of teammate characters. When the characters of which the attributes are the same or adapted to each other do not exist, characters of which skills are the same or adapted to each other are selected from the plurality of teammate characters. In addition, during selection, the terminal device preferentially selects teammate characters that have a same level, attribute, and skill, and then selects teammate characters that have higher levels or close attributes and skills when the teammate characters that have the same level, attribute, and skill do not exist.

In some embodiments, the combined attack skill may further be related to a state (for example, a health point or a magic value) of a virtual character. For example, only when a current state value of the first virtual character reaches a state threshold (for example, a magic value is greater than a magic threshold and is enough for the first virtual character to cast a corresponding skill), the first virtual character can form a lineup combination with a teammate character that meets the combined attack skill trigger condition or meets both the combined attack skill trigger condition and the set lineup combination, to cast the combined attack skill.

In some embodiments, before displaying the combined attack skill cast towards the second virtual character in the second camp, the terminal device may further perform the following processing: displaying a prompt identifier corresponding to at least one teammate character meeting the combined attack skill trigger condition in the virtual scene, the prompt identifier being in any form such as a word, an effect, or a combination of the two and being used for representing that the at least one teammate character and the first virtual character are capable of forming a lineup combination; and displaying the combined attack skill cast towards the second virtual character in the second camp in response to a selection operation on the at least one teammate character, the combined attack skill including the at least one attack skill cast by the first virtual character and at least one attack skill cast by the selected teammate character. Therefore, the prompt identifier corresponding to the at least one teammate character is displayed, it is convenient for the user to select the teammate character, a game progress is speed up, and a waiting time of a server is reduced, thereby reducing computing resources that need to be consumed by the server.

For example, FIG. 4C is a schematic diagram of an application scenario of a method for controlling a virtual character according to an embodiment of this application. As shown in FIG. 4C, when a user wants to control a first virtual character 416 to attack a second virtual character 420 belonging to an opposing camp, the terminal device may display a corresponding prompt identifier for a teammate character that meets the combined attack skill trigger condition in a virtual scene 400. For example, for a teammate character 418 that meets the combined attack skill trigger condition, a corresponding prompt identifier 419 may be displayed at the foot of the teammate character 418 and is used for prompting the user that the teammate character 418 is a virtual character that can form a lineup combination with the first virtual character 416. In addition, when receiving an attack instruction triggered by the user for the second virtual character, the terminal device may further display a corresponding attack identifier 417 at the foot of the first virtual character 416 and display a corresponding attacked identifier 421 at the foot of the second virtual character 420.

A display manner of the prompt identifier shown in FIG. 4C is merely a possible example. In actual application, the prompt identifier may further be displayed at the head of a virtual character or an effect is added to a virtual character to achieve prompt. This is not limited in this embodiment of this application.

In some embodiments, in event that the second virtual character in the second camp has a first strike skill (that is, the second virtual character has a privilege of preferentially casting a skill), before displaying the combined attack skill cast towards the second virtual character in the second camp, the terminal device may further perform the following processing: displaying at least one attack skill cast by the second virtual character towards the first virtual character and displaying a state of the first virtual character in response to the at least one attack skill cast by the second virtual character.

For example, when the second virtual character in the second camp (that is, a virtual character that the user prepares to attack) has a first strike skill, a corresponding battle time axis is that: the second virtual character attacks the first virtual character→the first virtual character attacks the second virtual character→the teammate character continues to attack the second virtual character. That is, in response to the positions of the first virtual character and the at least one teammate character in the first camp meeting the combined attack skill trigger condition, the terminal device first displays at least one attack skill cast by the second virtual character towards the first virtual character and displays a state of the first virtual character in response to the at least one attack skill cast by the second virtual character. For example, the second virtual character fails to attack the first virtual character, or the first virtual character is in a state in which a corresponding health point is reduced after bearing the attack of the second virtual character.

In some other embodiments, when the at least one teammate character has a guard skill (for example, it is assumed that a teammate character A in a lineup combination has a guard skill, that is, the second virtual character needs to first knock down the teammate character A before attacking the first virtual character), a corresponding battle time axis is that: the second virtual character attacks the teammate character A→the first virtual character attacks the second virtual character→the teammate character A attacks the second virtual character. That is, before displaying the at least one attack skill cast by the second virtual character towards the first virtual character, the terminal device may further display at least one attack skill cast by the second virtual character towards the at least one teammate character and display a state of the at least one teammate character in response to the at least one attack skill cast by the second virtual character (for example, a health point of the teammate character is reduced or a shield of the teammate character is broken after bearing the skill cast by the second virtual character, to lose a capability of guarding the first virtual character. In this case, the second virtual character may attack the first virtual character).

In some embodiments, in event that there is a third virtual character having a guard skill in the second camp, before displaying the combined attack skill cast towards the second virtual character, the terminal device may further perform the following processing: displaying the combined attack skill cast towards the third virtual character, and displaying a state of the third virtual character in response to the combined attack skill.

For example, there may further be a third virtual character having a guard skill in the second camp and the third virtual character is used for protecting the second virtual character. In this case, when the user wants to attack the second virtual character, the user first needs to attack the third virtual character. That is, in response to the positions of the first virtual character and the at least one teammate character in the first camp meeting the combined attack skill trigger condition, the terminal device first displays the combined attack skill cast towards the third virtual character and displays a state of the third virtual character in response to the combined attack skill, for example, the third virtual character is in a death state after bearing the combined attack skill.

In actual application, the third virtual character may alternatively be in an escape state, a state of losing a guard capability (for example, a shield of the third virtual character is broken after bearing the combined attack skill, to lose a capability of guarding the second virtual character), or a state of losing an attack capability in response to the combined attack skill.

In some other embodiments, continuing to the above, when the third virtual character is in the death state in response to the at least one attack skill cast by the first virtual character included in the combined attack skill (or the third virtual character cannot continue to guard the second virtual character due to escaping or losing the guard capability), the terminal device is further configured to perform the following processing: displaying at least one attack skill cast by the at least one teammate character towards the second virtual character, and displaying a state of the second virtual character in response to the at least one attack skill cast by the at least one teammate character.

For example, when the third virtual character is in the death state after bearing the at least one attack skill cast by the first virtual character included in the combined attack skill (the third virtual character disappears from the virtual scene), the at least one teammate character that forms the lineup combination with the first virtual character may continue to attack the second virtual character. That is, the terminal device may switch to display the at least one attack skill cast by the at least one teammate character towards the second virtual character and display the state of the second virtual character in response to the at least one attack skill cast by the at least one teammate character. For example, the second virtual character dodges the attack skill cast by the at least one teammate character or the second virtual character is in a death state after bearing the attack skill cast by the at least one teammate character.

In some embodiments, the terminal device may display the combined attack skill cast towards the second virtual character in the second camp in response to the positions of the first virtual character and the at least one teammate character in the first camp meeting the combined attack skill trigger condition in the following manners: combining, in response to positions of the first virtual character and a plurality of teammate characters in the first camp meeting the combined attack skill trigger condition, a teammate character having a largest attack power (or at least one of attack powers that rank high in descending order) in the plurality of teammate characters and the first virtual character into a lineup combination, and displaying the combined attack skill cast by the lineup combination towards the second virtual character, the combined attack skill including the at least one attack skill cast by the first virtual character and at least one attack skill cast by the teammate character having the largest attack power.

For example, when there are a plurality of teammate characters that meet the combined attack skill trigger condition in the virtual scene and no selection operation from the user on the plurality of teammate characters is received after a waiting time (for example, 10 seconds) is exceeded, the terminal device may sort the plurality of teammate characters in descending order of attack powers of the teammate characters, combine one teammate character having a highest attack power or at least one teammate character that ranks high and the first virtual character into a lineup combination, and display the combined attack skill cast by the lineup combination towards the second virtual character. Therefore, the teammate character having the highest attack power and the first virtual character are combined into the lineup combination, to perform a combination attack on the second virtual character, to cause largest damage to the second virtual character, and speed up the game process, thereby reducing the computing resources that need to be consumed by the terminal device.

In some embodiments, the combined attack skill may further be predicted by invoking a machine learning model. The machine learning model may run in the terminal device locally. For example, after training the machine learning model, the server delivers the trained machine learning model to the terminal device. The machine learning model may alternatively be deployed in the server. For example, after acquiring feature data of the first virtual character, the at least one teammate character, and the second virtual character, the terminal device uploads the feature data to the server, so that the server invokes the machine learning model based on the feature data, to determine a corresponding combined attack skill, and returns the determined combined attack skill to the terminal device. Therefore, the combined attack skill is accurately predicted by using the machine learning model, to avoid unnecessary repeated casting of the attack skill, thereby saving the computing resources of the terminal device.

The machine learning model may be a neural network model (for example, a convolutional neural network, a deep convolutional neural network, or a fully connected neural network), a decision tree model, a gradient boosting tree, a multi-layer perceptron, a support vector machine, or the like. A type of the machine learning model is not specifically limited in this embodiment of this application.

For example, in response to the positions of the first virtual character and the at least one teammate character in the first camp meeting the combined attack skill trigger condition, the terminal device may further perform the following processing: obtaining feature data of the first virtual character, the at least one teammate character, and the second virtual character, and invoking the machine learning model, to determine a quantity of times of casting attack skills respectively corresponding to the first virtual character and the teammate character included in the combined attack skill and a type of an attack skill cast each time, the feature data including at least one of the following: a state, a skill waiting time (or referred to as a cool down (CD) time, which refers to a time to be waited by continuously using a same skill (or prop), or a skill attack strength.

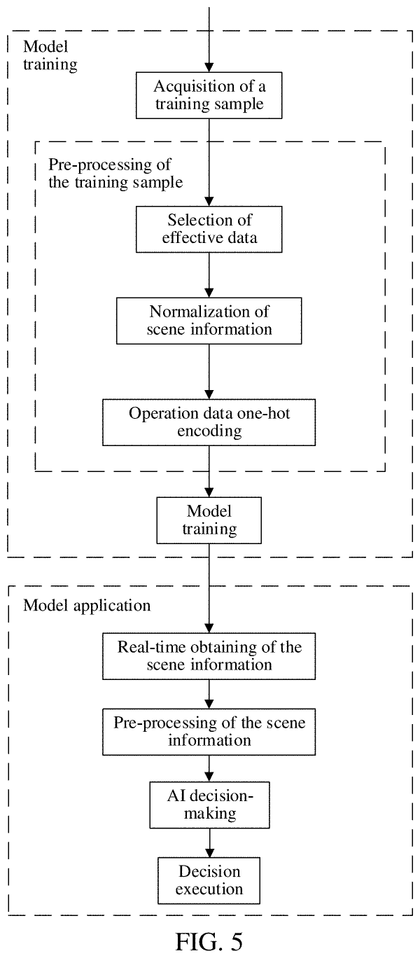

An example in which the machine learning model is the neural network model is used. FIG. 5 is a schematic diagram of training and application of a neural network model according to an embodiment of this application. Two stages of training and application of the neural network model are involved. A specific type of the neural network model is not limited, for example, may be a convolutional neural network model or a deep neural network.

The training stage of the neural network model mainly relates to the following parts: (a) acquisition of a training sample; (b) pre-processing of the training sample; and (c) training of the neural network model by using the pre-processed training sample. A description is made below.

(a) acquisition of a training sample. In some embodiments of this application, a real user may control a first virtual character and a teammate character to combine into a lineup combination and cast a combined attack skill towards a second virtual character in a second camp, basic game information (for example, whether the lineup combination controlled by the real user achieves winning, cool down times of skills of the first virtual character, and cool down times of skills of the teammate character), real-time scene information (for example, a current state (for example, a health point and a magic value) of the first virtual character, a current state of the teammate character, and a current state (for example, a current health point, a magic value, and waiting times of skills of the second virtual character) of the second virtual character), and an operation data sample (for example, a type of a skill cast by the first virtual character each time and a quantity of times of skill casting) of the real user are recorded, and then a date set obtained by combining the recorded data is used as a training sample of the neural network model.

(b) pre-processing of the training sample includes: performing operations such as selection, normalization processing, and encoding on the acquired training sample.

For example, selection of effective data includes: selecting a finally obtained type of cast attack skill and a corresponding quantity of times of casting from the acquired training sample.

For example, the normalization processing of scene information includes: normalizing the scene data to [0, 1]. For example, normalization processing may be performed on a cool down time corresponding to a skill 1 owned by the first virtual character in the following manners:

a normalized CD of the skill 1 of the first virtual character=CD of the skill 1 of the first virtual character/total CD of the skill 1.

The total CD of the skill 1 refers to a sum of CD of the skill 1 of the first virtual character and CD of the skill 1 of the teammate character.

For example, the operation data may be deserialized in a one-hot encoding manner. For example, for the operation data [whether a current state value of the first virtual character is greater than a state threshold, whether a current state value of the teammate character is greater than the state threshold, whether a current state value of the second virtual character is greater than the state threshold, . . . , whether the first virtual character casts the skill 1, and whether the teammate character casts the skill 1], a bit corresponding to an operation performed by the real user is set to 1, and others are set to 0. For example, when the current state value of the second virtual character is greater than the state threshold, the operation data is encoded as [0, 0, 1, . . . , 0, and 0].

(c) the neural network model is trained by using the pre-processed training sample.

For example, the neural network model is trained by using the pre-processed training sample. For example, feature data (which includes a state, a skill waiting time, a skill attack strength, and the like) of the first virtual character, the teammate character, and the second virtual character may be used as an input, and a quantity of times of casting attack skills in the combined attack skill and a type of an attack skill cast each time may be used as an outputted. Specifically,

Input: [the feature data of the first virtual character, the feature data of the teammate character, the feature data of the second virtual character]; and

Output: [a quantity of times of casting attack skills by the first virtual character, a type of an attack skill cast by the first virtual character each time, a quantity of times of casting attack skills by the teammate character, a type of an attack skill cast by the teammate character each time]

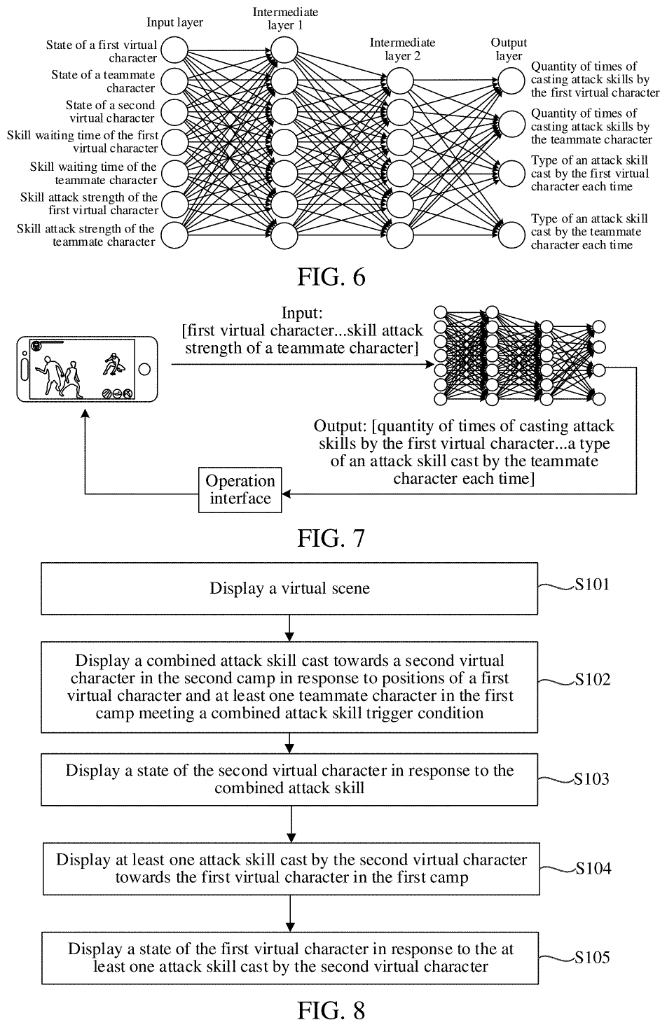

For example, FIG. 6 is a schematic structural diagram of a neural network model according to an embodiment of this application. As shown in FIG. 6, the neural network model includes an input layer, an intermediate value (for example, including an intermediate value 1 and an intermediate value 2), and an output layer. The neural network model may be trained on the terminal device by using a back propagation (BP) neural network algorithm. Certainly, in addition to the BP neural network, another type of neural network may further be used, for example, a recurrent neural network (RNN).

In some other embodiments, FIG. 7 is a schematic diagram of determining a combined attack skill according to feature data by using a neural network model according to an embodiment of this application. As shown in FIG. 7, the application stage of the neural network model involves the following parts: (a) obtaining scene data in an attack process in real time; (b) pre-processing the scene data; (c) inputting the pre-processed scene data into a trained neural network model, and calculating a combined attack skill outputted by the model; and (d) invoking a corresponding operation interface according to the combined attack skill outputted by the mode, so that the first virtual character and the teammate character cast the combined attack skill, which are respectively described below.

(a) Real-Time Obtaining of Scene Data in an Attack Process

After the first virtual character and the teammate character are combined into a lineup combination, a game program obtains scene data in an attack process in real time, for example, the feature data of the first virtual character, the feature data of the teammate character, and the feature data of the second virtual character.

(b) Pre-Processing of the Scene Data

The scene data is pre-processed in the game program. A specific manner is consistent with the pre-processing of the training sample, which includes normalization processing of the scene data and the like.

(c) Obtaining of the Combined Attack Skill

In the game program, the pre-processed scene data is used as an input, and the trained neural network model performs calculation to obtain an output, that is, the combined attack skill, which includes quantities of times of casting attack skills respectively corresponding to the first virtual character and the teammate character and a type of an attack skill cast each time.

(d) Execution of the Combined Attack Skill

The neural network model outputs a group of digits, which respectively correspond to [whether the first virtual character casts a skill 1, whether the first virtual character casts a skill 2, whether a quantity of times of casting the skill 1 by the first virtual character is greater than a time quantity threshold, . . . , whether the teammate character casts the skill 1], and a game operation corresponding to a maximum value entry in the output is performed by invoking a corresponding operation interface according to a result of the output.

In some embodiments, the terminal device may display the combined attack skill cast towards the second virtual character in the second camp in the following manners: controlling, when an attack range of the first virtual character is smaller than a range threshold and an attack range of the at least one teammate character is larger than the range threshold, the at least one teammate character to be at a fixed position relative to the first virtual character in a process in which the first virtual character casts the at least one attack skill; and controlling, when both the attack ranges of the first virtual character and the at least one teammate character are larger than the range threshold, the at least one teammate character to be at a fixed position in the virtual scene in the process in which the first virtual character casts the at least one attack skill.

For example, when the first virtual character is melee (that is, the attack range of the first virtual character is smaller than the range threshold, for example, the first virtual character can attack only another virtual character within one grid), and a teammate character B is remote (that is, an attack range of the teammate character B is larger than the range threshold, for example, the teammate character B can attack another virtual character within three grids), the teammate character B is always at a fixed position of the first virtual character, for example, at the left front of the first virtual character when the terminal device displays the at least one attack skill cast by the first virtual character.

For example, when both the first virtual character and the teammate character B are remote, the teammate character B is always at a fixed position in the virtual scene when the terminal device displays the at least one attack skill cast by the first virtual character. For example, the position of the teammate character B in the virtual scene does not change regardless of whether the first virtual character performs an attack at a position of three grids or one grid away from the second virtual character.

In some embodiments, the combined attack skill cannot be triggered in a limited state. For example, when determining that any virtual character of the first virtual character or the at least teammate character is in an abnormal state (for example, being dizzy, or sleeping, or a state value being less than the state threshold), the terminal device displays prompt information indicating that the combined attack skill is not castable in the human-computer interaction interface.

Step S103. Display a state of the second virtual character in response to the combined attack skill.

In some embodiments, when the second virtual character has a dodge skill, the terminal device displays a miss state of the second virtual character in response to the combined attack skill.

In some embodiments, when the second virtual character does not have the dodge skill, the terminal device displays a death state (or a health point is reduced but is not 0) of the second virtual character in response to the combined attack skill.

In some embodiments, FIG. 8 is a schematic flowchart of a method for controlling a virtual character according to an embodiment of this application. Based on FIG. 3, in event that the second virtual character is in a non-death state in response to the combined attack skill, after performing step S103, the terminal device may further perform step S104 and step S105 shown in FIG. 8, and a description is made in combination with the steps shown in FIG. 8.

Step S104. Display at least one attack skill cast by the second virtual character towards the first virtual character in the first camp.

In some embodiments, when the second virtual character is in a non-death state after bearing the combined attack skill, the second virtual character may strike back to the first virtual character. That is, after displaying the state of the second virtual character in response to the combined attack skill, the terminal device may continue to display at least one attack skill cast by the second virtual character towards the first virtual character in the first camp.

That is, in the foregoing embodiment, when the second virtual character performs counterattack, the second virtual character may attack only the first virtual character but does not attack the teammate character, to reduce complexity of a game, and speed up the game progress, thereby reducing the computing resources that need to be consumed by the terminal device in the game process. Certainly, in actual application, when performing counterattack, the second virtual character may alternatively attack the teammate character (for example, when the teammate character has a guard skill, that is, the second virtual character needs to first knock down the teammate character before attacking the first virtual character). This is not specifically limited in this embodiment of this application.

Step S105. Display a state of the first virtual character in response to the at least one attack skill cast by the second virtual character.

In some embodiments, when the first virtual character has a dodge skill, the terminal device may display a miss state of the first virtual character in response to the at least one attack skill cast by the second virtual character, that is, the second virtual character fails to attack the first virtual character, and a health point corresponding to the first virtual character does not change.

According to the method for controlling a virtual character provided in this embodiment of this application, when a user needs to control a first virtual character to attack a second virtual character in an opposing camp, the terminal device may trigger casting of a combined attack skill by using a position relationship between the first virtual character and a teammate character in a same camp in a virtual scene, to simplify a trigger mechanism of the combined attack skill, thereby reducing consumption of the computing resources of the terminal device.

The following describes an exemplary application of this embodiment of this application in an actual application scenario by using a war chess game as an example.

The war chess game is a kind of turn-based role-playing strategy game in which a virtual character is moved in a map according to a grid for battle. Because the game is like playing chess, it is also referred to as a turn-based chess game. It generally supports multi-terminal synchronous experiences such as a computer terminal and a mobile terminal. In a game process, users (or referred to as players) may control two or more virtual characters in a same camp to form an attack formation, to perform a combination attack on target virtual characters in an opposing camp.

However, in the related art, a trigger mechanism of the combination attack (which corresponds to the combined attack skill) is relatively complex and difficult to understand, a client needs to consume a large amount of computing resources of the terminal device when determining a combination attack trigger condition, resulting in a lag when a picture of the combination attack is displayed, and affecting user experience. In addition, when an attacked party also triggers the combination attack during counterattack, resulting in higher complexity of the game.

In view of this, the embodiments of this application provide a method for controlling a virtual character, which adds a combination effect in which a multi-person attack is triggered by using a lineup combination and an attack formation of users in a single round. For example, when a character (which corresponds to the first virtual character) that actively initiates an attack and a combiner (which corresponds to the teammate character) are in a same camp, and positions of the two meet a specific rule, a combination attack effect may be triggered. In addition, when the combination attack is triggered, there are different interaction prompt information (for example, prompt information of teammate characters that may participate in the combination attack in the virtual scene), attack performance, and an attack effect. Further, the combination attack is not triggered when an attacked party (which corresponds to the second virtual character) performs a counterattack, to speed up the game progress.

The following specifically describes the method for controlling a virtual character provided in this embodiment of this application.

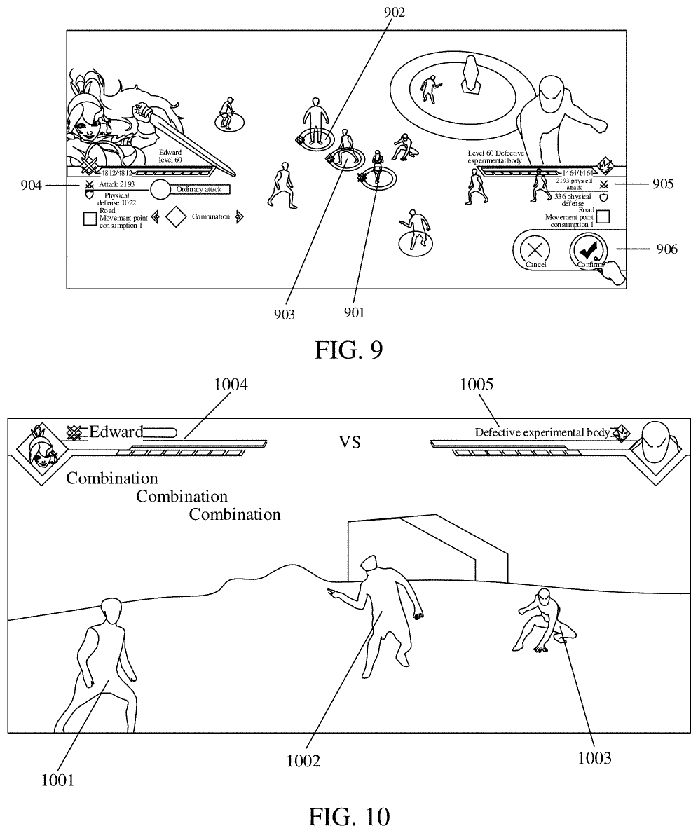

For example, FIG. 9 is a schematic diagram of an application scenario of a method for controlling a virtual character according to an embodiment of this application. As shown in FIG. 9, when a user wants to control a first virtual character 901 shown in FIG. 9 to attack a second virtual character 903 belonging to an opposing camp, a teammate character that may participate in a combination attack may be prompted in a virtual scene (for example, a teammate character 902 shown in FIG. 9, and a prompt light ring indicating that the teammate character may participate in the combination attack may be displayed at the foot of the teammate character 902). The first virtual character 901 and the teammate character 902 belong to a same camp, and the second virtual character 903 is within both attack ranges of the first virtual character 901 and the teammate character 902, that is, both the first virtual character 901 and the teammate character 902 can attack the second virtual character 903. In addition, a prompt box 906 indicating whether to determine to perform a combination attack may further be displayed in the virtual scene, and “cancel” and “confirm” buttons are displayed in the prompt box 906. When receiving a click/tap operation on the “confirm” button displayed in the prompt box 906 from the user, the client combines the first virtual character 901 and the teammate character 902 into an attack formation (or a lineup combination), to perform the combination attack in a subsequent attack process.

In addition, as shown in FIG. 9, attribute information 904 such as a name, a level, an attack power, a defense power, and a health point of the first virtual character 901 may further be displayed in the virtual scene. Attribute information 905 such as a level, a name, an attack power, a defense power, and a health point of the second virtual character 903 may also be displayed in the virtual scene. Therefore, attribute information of a you character (that is, the first virtual character 901) and attribute information of an enemy character (that is, the second virtual character 903) are displayed in the virtual scene, so that the user is convenient to perform comparison to adjust a subsequent battle decision.

In some embodiments, when a plurality of teammate characters belonging to a same camp as the first virtual character meet a condition of participating in a combination attack in the virtual scene, the client may select a teammate character with a highest attack power (or a highest defense power) by default to participate in the combination attack and support the user to manually select a teammate character to participate in the combination attack, that is, the client may determine, in response to a selection operation of the user on the plurality of teammate characters, a character selected by the user as a teammate character that subsequently participates in the combination attack with the first virtual character.

In some other embodiments, when any virtual character of the first virtual character or the teammate character is in an abnormal state, the combination attack cannot be performed. For example, when the first virtual character is currently in an abnormal state such as being dizzy or sleeping, the first virtual character cannot perform the combination attack, that is, the prompt box 906 shown in FIG. 9 is not displayed in the virtual scene.

For example, FIG. 10 is a schematic diagram of an application scenario of a method for controlling a virtual character according to an embodiment of this application. As shown in FIG. 10, after the user clicks/taps the “confirm” button in the prompt box 906 shown in FIG. 9, the client responds to the operation and jumps to a picture of displaying attack performance of the combination attack shown in FIG. 10. After a first virtual character 1001 attacks a second virtual character 1003 in an opposing camp, a teammate character 1002 enters a combination attack and attacks the second virtual character 1003 (FIG. 10 shows a picture in which the teammate character 1002 is moving to a position of the second virtual character 1003 and attacks the second virtual character). In addition, a health point and state 1004 (for example, a rage and a magic value) of the first virtual character 1001 and a health point and state 1005 (for example, a rage and a magic value) of the second virtual character 1003 may further be displayed in the virtual scene.

In some embodiments, when a virtual character having a guard skill in the opposing camp participates in a battle, the virtual character having the guard skill is preferentially attacked. For example, when a third virtual character shown in FIG. 10 that has a guard skill and belongs to a same camp as the second virtual character 1003 participates in the battle, the first virtual character 1001 and the teammate character 1002 shown in FIG. 10 first attack the third virtual character having the guard skill in the opposing camp, and may continue to attack the second virtual character 1003 after the third virtual character dies.

In some other embodiments, when the first virtual character is melee (that is, an attack range of the first virtual character is smaller than the range threshold, for example, the first virtual character can attack only a target within one grid), and the teammate character is remote (that is, an attack range of the teammate character is larger than the range threshold, for example, the teammate character may attack a target within three grids), the teammate character is at a fixed position of the first virtual character (for example, the teammate character may be at a left front fixed position of the first virtual character) when the client displays battle performance of the combination attack. However, when both the first virtual character and the teammate character are remote, the teammate character is at a fixed position, that is, the teammate character does not move with the first virtual character, when the client displays the attack performance of the combination attack.

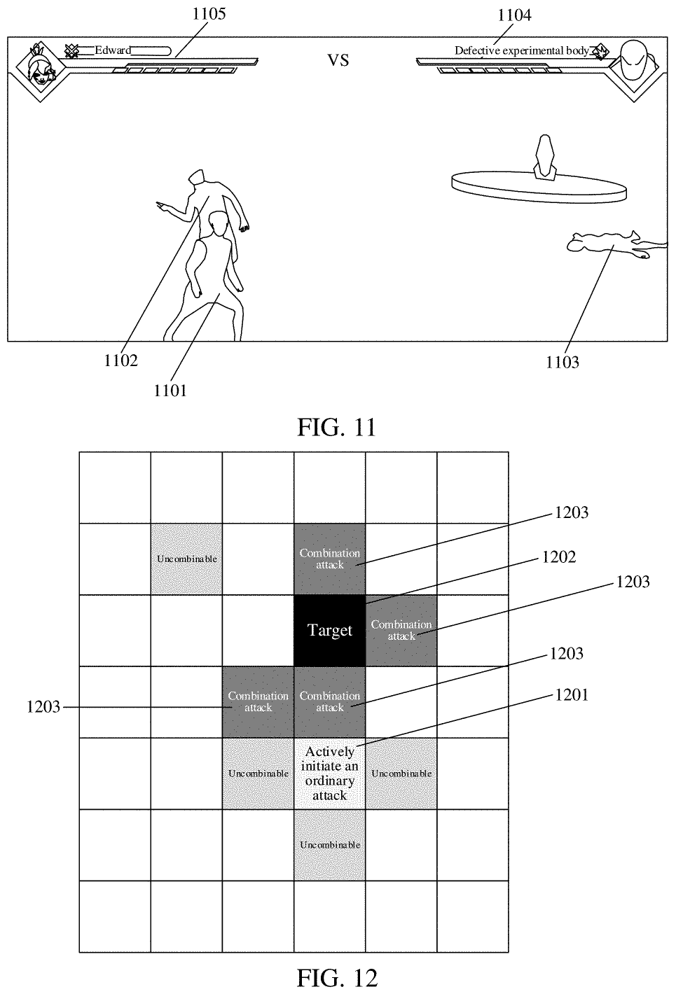

For example, FIG. 11 is a schematic diagram of an application scenario of a method for controlling a virtual character according to an embodiment of this application. As shown in FIG. 11, after attacking a second virtual character 1103, a teammate character 1102 exits to a fixed position of a first virtual character 1101, for example, exits to a left front fixed position of the first virtual character 1101. In addition, after both the first virtual character 1101 and the teammate character 1102 attack the second virtual character 1103, a state of the second virtual character 1103 in response to a combination attack of the first virtual character 1101 and the teammate character 1102 is displayed, for example, a “death” state shown in FIG. 11. That is, the client determines an attack initiated by the first virtual character 1101 and an attack initiated by the teammate character 1102 as a complete attack. When the second virtual character 1103 is in the “death” state after bearing the attack of the first virtual character 1101, the client still continues to display an attack picture in which the teammate character 1102 attacks the second virtual character 1103. That is, according to the method for controlling a virtual character provided in this embodiment of this application, an implementation in which the client performs determining based on a local logic is used when game data is processed, to perform uniform asynchronous verification on damage and effect change caused by the combination attack after settlement of a single round.

In addition, as shown in FIG. 11, a health point and state 1105 (for example, a rage and a magic value) of the first virtual character 1101 after attack and a remaining health point and state 1104 (for example, a rage and a magic value) of the second virtual character 1103 after bearing the combination attack of the first virtual character 1101 and the teammate character 1102 may further be displayed in the virtual scene, for example, after the second virtual character 1103 dies, a corresponding health value is changed into 0.

A rule of triggering the combination attack is described below.

For example, in a game process, when a user wants to control a virtual character (that is, the first virtual character) to attack a target character (that is, the second virtual character in the opposing camp) in a virtual scene, the client may select, according to a position and camp information of the virtual character controlled by the user, a teammate character that may participate in a combination attack from the virtual scene. For example, FIG. 12 is a schematic diagram of a rule of triggering a combination attack according to an embodiment of this application. As shown in FIG. 12, the client may determine, according to a position of a virtual character controlled by a user (for example, a position of “actively initiating an ordinary attack” 1201 shown in FIG. 12) and a position (for example, a position of a “target” 1202 shown in FIG. 12) of an attacked party (which corresponds to the second virtual character), positions (for example, positions of “combinable attacks” 1203 shown in FIG. 12) that may participate in a combination attack in a virtual scene and may display prompt information in characters at the positions (that is, the plurality of “combinable attacks” 1203 shown in FIG. 12) and belonging to a same camp as the virtual character controlled by the user, to prompt the user that the characters may participate in the combination attack.

An attack sequence of virtual characters in different camps is described below.

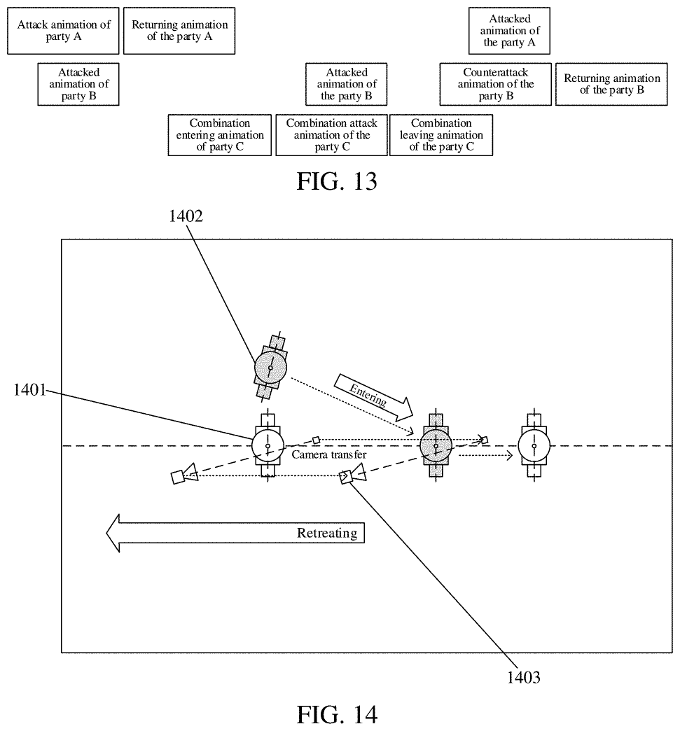

For example, according to the method for controlling a virtual character provided in this embodiment of this application, a battle time axis may be that: an active party (which corresponds to the first virtual character) first performs an attack, a combiner (which corresponds to the teammate character) continues to perform an attack, and an attacked party (which corresponds to the second virtual character) performs a counterattack. For example, FIG. 13 is a schematic diagram of a design of an attack sequence according to an embodiment of this application. As shown in FIG. 13, the client first displays an attack animation of a party A (which corresponds to the first virtual character), an attacked animation of a party B (which corresponds to the second virtual character), and a returning animation of the party A when displaying a picture of a combination attack. So far, the party A completes the attack. Next, the client displays a combination entering animation of a party C (which corresponds to the teammate character), a combination attack animation of the party C, an attacked animation of the party B, a combination leaving animation of the party C. So far, the party C completes the attack. Subsequently, the client displays a counterattack animation of the party B, an attacked animation of the party A, and a returning animation of the party B. So far, the party B completes the counterattack.

In some other embodiments, when an attacked party (which corresponds to the second virtual character) has a first strike skill, that is, preferentially casts a counterattack skill, the battle time axis may be adjusted as that: the attacked party performs a counterattack, the active party (which corresponds to the first virtual character) performs an attack, and the combiner (which corresponds to the teammate character) continues to perform an attack.

In addition, the attack of the active party and the attack of the combiner are considered as complete attack performance, that is, if after the active party performs the attack, a health point of the attacked party is empty (that is, in a death state), the client continues to display the attack picture of the combiner for the attacked party, that is, after the attack pictures of the active party and the combiner are displayed in sequence, the death state of the attacked party is displayed.

A lens design process when the client displays battle performance of the combination attack is described below.

For example, FIG. 14 is a schematic diagram of a lens design in a combination attack process according to an embodiment of this application. As shown in FIG. 14, during lens control when a combination skill is cast, the client performs automatic fitting and adaptation according to a current attack unit such as a position of an active attacker 1401 (which corresponds to the first virtual character) or a combiner 1402 (which corresponds to the teammate character) shown in FIG. 14 and a dynamic Lookat (Lookat refers to a focus direction of a camera, that is, which point a camera 1403 looks at) focus position. For example, when the active attacker 1401 performs an attack, the camera 1403 may look at a position between the active attacker 1401 and an attacked party (which corresponds to the second virtual character), and when the combiner 1402 is switched to perform an attack, the camera 1403 may look at a position between the combiner 1402 and the attacked party (not shown in the figure). In addition, after the combiner 1402 completes the attack, the camera 1403 may look at the position between the active attacker 1401 and the attacked party again. In addition, when the active attacker 1401 or the combiner 1402 moves, for example, the active attacker 1401 moves to a position of the attacked party to perform an attack, the camera 1403 may also move, to display a dynamic effect of zooming out and in according to forward and backward movements of the active attacker 1401. Further, the camera 1403 may also display a vibration effect according to the forward and backward or left and right movements of the active attacker 1401 or the combiner 1402.

The following continues to describe an exemplary structure in which the apparatus 455 for controlling a virtual character provided in this embodiment of this application is implemented as a software module, and in some embodiments, as shown in FIG. 2, the software module in the apparatus 455 for controlling a virtual character stored in the memory 450 may include:

a display module 4551, configured to display a virtual scene, the virtual scene including a first camp and a second camp that fight against each other; and the display module 4551 being further configured to display a combined attack skill cast towards a second virtual character in the second camp in response to positions of a first virtual character and at least one teammate character in the first camp meeting a combined attack skill trigger condition; and display a state of the second virtual character in response to the combined attack skill, the combined attack skill including at least one attack skill cast by the first virtual character and at least one attack skill cast by the at least one teammate character.

In some embodiments, the combined attack skill trigger condition may include at least one of the following: a position of the second virtual character in the virtual scene is within an attack range of the first virtual character and is within an attack range of the at least one teammate character; or an orientation of the first virtual character relative to the at least one teammate character is a set orientation or falls within a set orientation range.

In some embodiments, the display module 4551 is further configured to display the combined attack skill cast towards the second virtual character in the second camp in response to the positions of the first virtual character and the at least one teammate character in the first camp meeting the combined attack skill trigger condition and character types of the first virtual character and the at least one teammate character meeting a set lineup combination.

In some embodiments, the set lineup combination including at least one of the following: a level of the first virtual character is lower than or equal to a level of the at least one teammate character; or attributes of the first virtual character and the at least one teammate character are the same or adapted to each other; or skills of the first virtual character and the at least one teammate character are the same or adapted to each other.

In some embodiments, when the second virtual character has a first strike skill, before displaying the combined attack skill cast towards the second virtual character in the second camp, the display module 4551 is further configured to display at least one attack skill cast by the second virtual character towards the first virtual character and display a state of the first virtual character in response to the at least one attack skill cast by the second virtual character.

In some embodiments, when the at least one teammate character has a guard skill, before displaying the at least one attack skill cast by the second virtual character towards the first virtual character, the display module 4551 is further configured to display at least one attack skill cast by the second virtual character towards the at least one teammate character and display a state of the at least one teammate character in response to the at least one attack skill cast by the second virtual character.

In some embodiments, when there is a third virtual character having a guard skill in the second camp, before displaying the combined attack skill cast towards the second virtual character, the display module 4551 is further configured to display the combined attack skill cast towards the third virtual character, and display a state of the third virtual character in response to the combined attack skill.

In some embodiments, when the third virtual character is in a death state in response to at least one attack skill cast by the first virtual character included in the combined attack skill, the display module 4551 is further configured to display at least one attack skill cast by the at least one teammate character towards the second virtual character, and display a state of the second virtual character in response to the at least one attack skill cast by the at least one teammate character.

In some embodiments, before displaying the combined attack skill cast towards the second virtual character in the second camp, the display module 4551 is further configured to display a prompt identifier corresponding to the at least one teammate character for the at least teammate character meeting the combined attack skill trigger condition in the virtual scene, the prompt identifier being used for representing that the at least one teammate character and the first virtual character are capable of forming a lineup combination; and display the combined attack skill cast towards the second virtual character in the second camp in response to a selection operation on the at least one teammate character, the combined attack skill including the at least one attack skill cast by the first virtual character and the at least one attack skill cast by the selected teammate character.

In some embodiments, the display module 4551 is further configured to combine, in response to positions of the first virtual character and a plurality of teammate characters in the first camp meeting the combined attack skill trigger condition, a teammate character having a largest attack power in the plurality of teammate characters and the first virtual character into a lineup combination, and display the combined attack skill cast by the lineup combination towards the second virtual character, the combined attack skill including the at least one attack skill cast by the first virtual character and at least one attack skill cast by the teammate character having the largest attack power.

In some embodiments, the display module 4551 is further configured to control, when an attack range of the first virtual character is smaller than a range threshold and an attack range of the at least one teammate character is larger than the range threshold, the at least one teammate character to be at a fixed position relative to the first virtual character in a process in which the first virtual character casts the at least one attack skill; and control, when both the attack ranges of the first virtual character and the at least one teammate character are larger than the range threshold, the at least one teammate character to be at a fixed position in the virtual scene in the process in which the first virtual character casts the at least one attack skill.

In some embodiments, the display module 4551 is further configured to display, when the second virtual character is in a non-death state in response to the combined attack skill, at least one attack skill cast by the second virtual character towards the first virtual character in the first camp, and display a state of the first virtual character in response to the at least one attack skill cast by the second virtual character; and display, when any virtual character of the first virtual character or the at least teammate character is in an abnormal state, prompt information indicating that the combined attack skill is not castable.

In some embodiments, the combined attack skill is predicted by invoking a machine learning model. The apparatus 455 for controlling a virtual character further includes an obtaining module 4552, configured to obtain feature data of the first virtual character, the at least one teammate character, and the second virtual character. The apparatus 455 for controlling a virtual character further includes an invoking module 4553, configured to invoke the machine learning model based on the feature data, to determine a quantity of times of casting of attack skills included in the combined attack skill and a type of an attack skill cast each time, the feature data including at least one of the following: a state, a skill waiting time, or a skill attack strength.

Descriptions of the foregoing apparatus in this embodiment of this application are similar to the descriptions of the method embodiments. The apparatus embodiments have beneficial effects similar to those of the method embodiments and thus are not repeatedly described. Technical details that are not disclosed in the apparatus for controlling a virtual character provided in this embodiment of this application are described and understood according to any accompanying drawing of FIG. 3 or FIG. 8.

An embodiment of this application provides a computer program product or a computer program. The computer program product or the computer program includes computer instructions, and the computer instructions are stored in a computer-readable storage medium. A processor of a computer device reads the computer instructions from the computer-readable storage medium. The processor executes the computer instructions, to cause the computer device to perform the method for controlling a virtual character according to the embodiments of this application.

An embodiment of this application provides a computer-readable storage medium storing executable instructions. When the executable instructions are executed by a processor, the processor is caused to perform the method for controlling a virtual character in the embodiments of this application, for example, the method for controlling a virtual character shown in FIG. 3 or FIG. 8.

In some embodiments, the computer-readable storage medium may be a memory such as a ferroelectric RAM (FRAM), a ROM, a programmable ROM (PROM), an electrically programmable ROM (EPROM), an electrically erasable PROM (EEPROM), a flash memory, a magnetic surface memory, an optical disk, or a CD-ROM, or may be any device including one of or any combination of the foregoing memories.

In some embodiments, the executable instructions can be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

In an example, the executable instructions can be deployed for execution on one computing device, execution on a plurality of computing devices located at one location, or execution on a plurality of computing devices that are distributed at a plurality of locations and that are interconnected through a communication network.

Based on the foregoing, in the embodiments of this application, when a user needs to control a first virtual character to attack a second virtual character in an opposing camp, the terminal device may trigger casting of a combined attack skill by using a position relationship between the first virtual character and a teammate character in a same camp in a virtual scene, to simplify a trigger mechanism of the combined attack skill, thereby reducing consumption of the computing resources of the terminal device.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A method for controlling a virtual character, performed by an electronic device, the method comprising:
displaying a virtual scene, the virtual scene comprising a first camp and a second camp that fight against each other;
displaying a combined attack skill cast towards a second virtual character in the second camp in response to positions of a first virtual character and at least one teammate character in the first camp meeting a combined attack skill trigger condition; and
displaying a state of the second virtual character in response to the combined attack skill,
the combined attack skill comprising at least one attack skill cast by the first virtual character and at least one attack skill cast by the at least one teammate character.

2. The method according to claim 1, wherein the combined attack skill trigger condition comprises at least one:
a position of the second virtual character in the virtual scene is within an attack range of the first virtual character and is within an attack range of the at least one teammate character; or
an orientation of the first virtual character relative to the at least one teammate character is a set orientation or falls within a set orientation range.

3. The method according to claim 1, wherein the displaying a combined attack skill cast towards a second virtual character in the second camp in response to positions of a first virtual character and at least one teammate character in the first camp meeting a combined attack skill trigger condition comprises:
displaying the combined attack skill cast towards the second virtual character in the second camp in response to the positions of the first virtual character and the at least one teammate character in the first camp meeting the combined attack skill trigger condition and character types of the first virtual character and the at least one teammate character meeting a set lineup combination.

4. The method according to claim 3, wherein the set lineup combination comprises at least one of:
a level of the first virtual character is lower than or equal to a level of the at least one teammate character;
attributes of the first virtual character and the at least one teammate character are the same or adapted to each other; or
skills of the first virtual character and the at least one teammate character are the same or adapted to each other.

5. The method according to claim 1, wherein when the second virtual character has a first strike skill, before the displaying a combined attack skill cast towards a second virtual character in the second camp, the method further comprises:
displaying at least one attack skill cast by the second virtual character towards the first virtual character; and
displaying a state of the first virtual character in response to the at least one attack skill cast by the second virtual character.

6. The method according to claim 5, wherein when the at least one teammate character has a guard skill, before the displaying at least one attack skill cast by the second virtual character towards the first virtual character, the method further comprises:
displaying at least one attack skill cast by the second virtual character towards the at least one teammate character; and
displaying a state of the at least one teammate character in response to the at least one attack skill cast by the second virtual character.

7. The method according to claim 1, wherein when the second camp comprises a third virtual character having a guard skill, before the displaying a combined attack skill cast towards the second virtual character, the method further comprises:
displaying the combined attack skill cast towards the third virtual character, and displaying a state of the third virtual character in response to the combined attack skill.

8. The method according to claim 7, wherein when the third virtual character is in a death state in response to the at least one attack skill cast by the first virtual character comprised in the combined attack skill, the method further comprises:
displaying the at least one attack skill cast by the at least one teammate character towards the second virtual character; and
displaying a state of the second virtual character in response to the at least one attack skill cast by the at least one teammate character.

9. The method according to claim 1, wherein before the displaying a combined attack skill cast towards a second virtual character in the second camp, the method further comprises:
displaying a prompt identifier corresponding to at least teammate character meeting the combined attack skill trigger condition in the virtual scene, the prompt identifier used to represent that the at least one teammate character and the first virtual character are capable of forming a lineup combination; and
displaying the combined attack skill cast towards the second virtual character in the second camp in response to a selection operation on the at least one teammate character,
the combined attack skill comprising the at least one attack skill cast by the first virtual character and at least one attack skill cast by the selected teammate character.

10. The method according to claim 1, wherein the displaying a combined attack skill cast towards a second virtual character in the second camp in response to positions of a first virtual character and at least one teammate character in the first camp meeting a combined attack skill trigger condition comprises:
combining, in response to positions of the first virtual character and a plurality of teammate characters in the first camp meeting the combined attack skill trigger condition, a teammate character having a largest attack power in the plurality of teammate characters and the first virtual character into a lineup combination, and displaying the combined attack skill cast by the lineup combination towards the second virtual character,
the combined attack skill comprising the at least one attack skill cast by the first virtual character and at least one attack skill cast by the teammate character having the largest attack power.

11. The method according to claim 1, wherein the displaying a combined attack skill cast towards a second virtual character in the second camp comprises:
controlling, when an attack range of the first virtual character is smaller than a range threshold and an attack range of the at least one teammate character is larger than the range threshold, the at least one teammate character to be at a fixed position relative to the first virtual character in a process in which the first virtual character casts the at least one attack skill; and
controlling, when both the attack ranges of the first virtual character and the at least one teammate character are larger than the range threshold, the at least one teammate character to be at a fixed position in the virtual scene in the process in which the first virtual character casts the at least one attack skill.

12. The method according to claim 1, further comprising:
displaying, when the second virtual character is in a non-death state in response to the combined attack skill, at least one attack skill cast by the second virtual character towards the first virtual character in the first camp, and displaying a state of the first virtual character in response to the at least one attack skill cast by the second virtual character; and
displaying, when any virtual character of the first virtual character or the at least teammate character is in an abnormal state, prompt information indicating that the combined attack skill is not castable.

13. The method according to claim 1, wherein
the combined attack skill is predicted by invoking a machine learning model; and
when the positions of the first virtual character and the at least one teammate character in the first camp meet the combined attack skill trigger condition, the method further comprises:
obtaining feature data of the first virtual character, the at least one teammate character, and the second virtual character, and invoking the machine learning model based on the feature data, to determine a quantity of times of casting of attack skills comprised in the combined attack skill and a type of an attack skill cast each time,
the feature data comprising at least one of: a state, a skill waiting time, or a skill attack strength.

14. An electronic device, comprising:
a memory storing a plurality of instructions; and
a processor configured to execute the plurality of instructions, and upon execution of the plurality of instructions, is configured to cause a display to:
display a virtual scene, the virtual scene comprising a first camp and a second camp that fight against each other;
display a combined attack skill cast towards a second virtual character in the second camp in response to positions of a first virtual character and at least one teammate character in the first camp meeting a combined attack skill trigger condition; and
display a state of the second virtual character in response to the combined attack skill,
the combined attack skill comprising at least one attack skill cast by the first virtual character and at least one attack skill cast by the at least one teammate character.

15. The electronic device according to claim 14, wherein the combined attack skill trigger condition comprises at least one of:
a position of the second virtual character in the virtual scene is within an attack range of the first virtual character and is within an attack range of the at least one teammate character; or
an orientation of the first virtual character relative to the at least one teammate character is a set orientation or falls within a set orientation range.

16. The electronic device according to claim 14, wherein in order to display a combined attack skill cast towards a second virtual character in the second camp in response to positions of a first virtual character and at least one teammate character in the first camp meeting a combined attack skill trigger condition, the processor, upon execution of the plurality of instructions, is configured to cause the display to:
display the combined attack skill cast towards the second virtual character in the second camp in response to the positions of the first virtual character and the at least one teammate character in the first camp meeting the combined attack skill trigger condition and character types of the first virtual character and the at least one teammate character meeting a set lineup combination.

17. The electronic device according to claim 14, wherein when the second virtual character has a first strike skill, before the display of the combined attack skill cast towards a second virtual character in the second camp, the processor, upon execution of the plurality of instructions, is further configured to:
display at least one attack skill cast by the second virtual character towards the first virtual character; and
display a state of the first virtual character in response to the at least one attack skill cast by the second virtual character.

18. The electronic device according to claim 14, wherein when the second camp comprises a third virtual character having a guard skill, before the display of the combined attack skill cast towards the second virtual character, the processor, upon execution of the plurality of instructions, is further configured to:
display the combined attack skill cast towards the third virtual character, and display a state of the third virtual character in response to the combined attack skill.

19. The electronic device according to claim 14, wherein before the display of the combined attack skill cast towards a second virtual character in the second camp, the processor, upon execution of the plurality of instructions, is further configured to:
display a prompt identifier corresponding to at least teammate character meeting the combined attack skill trigger condition in the virtual scene, the prompt identifier used to represent that the at least one teammate character and the first virtual character are capable of forming a lineup combination; and
display the combined attack skill cast towards the second virtual character in the second camp in response to a selection operation on the at least one teammate character,
the combined attack skill comprising the at least one attack skill cast by the first virtual character and at least one attack skill cast by the selected teammate character.

20. A non-transitory computer-readable storage medium storing a plurality of instructions executable by a processor, and when executed by the processor, is configured to cause the processor to cause a display to:
display a virtual scene, the virtual scene comprising a first camp and a second camp that fight against each other;
display a combined attack skill cast towards a second virtual character in the second camp in response to positions of a first virtual character and at least one teammate character in the first camp meeting a combined attack skill trigger condition; and
display a state of the second virtual character in response to the combined attack skill,
the combined attack skill comprising at least one attack skill cast by the first virtual character and at least one attack skill cast by the at least one teammate character.
